(19) United States
(12) Patent Application Publication
(10) Pub. No.: US 2020/0210402 A1
(43) Pub. Date: Jul. 2, 2020

(54) SYSTEMS AND METHODS FOR PERFORMING PROGRAMMABLE SMART CONTRACT EXECUTION

(71) Applicant: Accelor Ltd., George Town (KY)

(72) Inventors: Shiwen HU, Sunnyvale, CA (US); Xiaohan MA, Santa Clara, CA (US); Guojun CHU, Saratoga, CA (US)

(21) Appl. No.: 16/236,243

(22) Filed: Dec. 28, 2018

(51) Int. Cl. G06F 16/23; G06F 9/30; G06Q 20/38; H04L 9/32

(52) U.S. Cl. CPC G06F 16/2365; H04L 9/3247; G06Q 20/389; G06F 9/3004

(57) ABSTRACT

Systems and methods related to a fixed pipeline hardware architecture configured to execute smart contracts in an isolated environment separate from a computing processing unit are described herein. Executing a smart contract may comprise performing a set of distributed ledger operations to modify a ledger associated with a decentralized application. The fixed pipeline hardware architecture may comprise and/or be incorporated within a self-contained hardware device comprising electronic circuitry configured to be communicatively coupled or physically attached to a component of a computer system. The hardware device may be specifically programmed to execute, and perform distributed ledger operations associated with, particular smart contracts, or types of smart contracts, that administer different decentralized applications and/or one or more aspects of different decentralized applications.

### FIELD OF THE INVENTION

The invention relates to systems and methods for processing transaction verification operations in decentralized applications via a fixed pipeline hardware architecture.

### BACKGROUND OF THE INVENTION

Decentralized applications are applications that run on peer-to-peer networks, rather than on a single computer. Transactions associated with decentralized applications are typically processed by nodes (or computers) on the peer-to-peer network based on trustless protocols or a series of validation rules established by the creators of the decentralized application. A critical component of decentralized applications is the manner in which transactions associated with the decentralized application are verified and recorded.

In many decentralized applications, verified transactions and/or other information is committed to a blockchain. Many types of blockchains exist. In general, they are distributed ledgers shared by the nodes on a network to which transactions are recorded and validated. A block is a part of a blockchain, in which some or all of the recent transactions may be recorded. Once completed, a block is stored in the blockchain as a permanent database. Each time a block gets completed, a new one is generated. Each block in the blockchain is connected to the others (like links in a chain) in proper linear, chronological order. Every block contains a hash of the previous block. The blockchain has information about different user addresses and their balances right from the genesis block to the most recently completed block.

Another critical component of decentralized applications are smart contracts. A smart contract can be thought of as computerized transaction protocol that executes terms of a contract. In other words, smart contracts are essentially self-executing contracts with the terms of an agreement between parties being directly written into and executed by lines of code. The code and the agreements contained therein can exist across a distributed, decentralized blockchain network. Using a scripting language or other techniques, a smart contract can include logic-based programs that run on top of a blockchain.

For most decentralized applications operating on blockchain-based systems, smart contracts are utilized to administer the decentralized application and/or one or more aspects of the decentralized application. For example, when a user generates a transaction, at least one endorsement is required. Another user (such as a banker in the case of a bank transaction) may endorse the user's transaction. This endorsed transaction may comprise a smart contract. In conventional blockchain-based system, the ledger embodied by the blocks of a blockchain may be accessed and modified directly by the computer (or CPU) at any node on the peer-to-peer network by executing smart contracts.

Conventional smart contracts involved rather simple transactions, such as the example described above. However, recent advances in blockchain-based and blockchain-inspired applications have led to much more complex smart contracts. These complex smart contracts are designed for particular implementations (e.g., payment, lottery, auctions, lending, and/or other unique applications of smart contracts) and, in some instances, may include and/or interface with one or more artificial intelligence components. Executing these more complex smart contracts involve computationally intensive power-consuming operations that, when performed by a CPU, inhibit the ability of the CPU to perform other operations simultaneously.

Additionally, the execution of smart contracts typically represent the most vulnerable stage of a blockchain-based system. In order to attack the system, a hacker may write a malicious smart contract, install it onto the system by hacking the CPU, and follow it with overflow or reentry attacks. In doing so, the hacker may take advantage of the host by essentially modifying the blockchain to their advantage. For example, attacking the system in this way may enable a hacker to withdraw a customer's balance, thus jeopardizing the security of the entire system. The smart contracts themselves may also have a direct relationship to financial data or other sensitive private information, which may be obtained by a hacker by taking advantage of the known and unknown vulnerabilities of any given CPU on a peer-to-peer network. It would be desirable to provide systems and methods that improve the performance of a CPU during the execution of smart contracts and address the privacy and security concerns associated with many decentralized applications.

### SUMMARY OF THE INVENTION

The systems and methods described herein relate to a fixed pipeline hardware architecture configured to execute smart contracts in an isolated environment separate from a computing processing unit. Executing a smart contract may comprise performing a set of distributed ledger operations to modify a ledger associated with a decentralized application. The fixed pipeline hardware architecture may comprise and/or be incorporated within a self-contained hardware device comprising electronic circuitry configured to be communicatively coupled or physically attached to a component of a computer system. The hardware device may include local memory and an array of execution units. The hardware device may be specifically programmed to execute, and perform distributed ledger operations associated with, particular smart contracts, or types of smart contracts, that administer different decentralized applications and/or one or more aspects of different decentralized applications. By moving the execution of smart contracts to an isolated environment, the risks associated with attacks from hackers may be dramatically reduced.

In various implementations, local memory on the hardware device may be configured to store a copy of a ledger shared by a plurality of nodes on a network. The local memory may also be configured to store self contracts to be executed by the hardware device, instructions for an instruction set architecture (ISA), and/or other information or instructions necessary to execute smart contracts on the hardware component itself. The ISA may comprise an interface between computer program instructions and components of the hardware component (e.g., the array of execution units on the hardware component). Instructions stored in local memory may program the array of execution units to perform one or more distributed ledger operations required to execute a smart contract of a decentralized application.

In various implementations, the hardware device may be specifically programmed to execute one or more types of smart contracts. For example, the hardware device may be specifically programmed to execute smart contracts related to payment transactions, a lottery (or wager), an auction, lending, and/or one or more other types of smart contracts. The array of execution units included in the hardware device may be capable of performing each distributed ledger operation required to execute a smart contract. For example, mathematical operations required to execute a smart contract may be routed to an execution engine, memory access operations required to execute a smart contract may be routed to a direct memory access (DMA) engine, and cryptographic operations required to execute a smart contract may be routed to a crypto engine. As such, the hardware device itself may be configured to fully execute any smart contract. Computer program instructions received that program the hardware device to perform the distributed ledger operations may define the distributed ledger operations to perform and the order in which the operations are to be performed. Performing the distributed ledger operations in order dramatically reduces the risk of side channel attacks.

These and other objects, features, and characteristics of the system and/or method disclosed herein, as well as the methods of operation and functions of the related elements of structure and the combination thereof, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 depicts a block diagram of an example of a system configured to process transaction verification operations in decentralized applications, in accordance with one or more implementations of the invention.

FIG. 2 illustrates a block diagram of an example of a read set validation engine configured to fetch ledger data and validate the ledger reading set against the global state, in accordance with one or more implementations of the invention.

FIG. 3 illustrates a block diagram of an example of a crypto engine configured to perform one or more cryptographic operations required to verify the authenticity of transactions in a block, in accordance with one or more implementations of the invention.

FIG. 4 illustrates a block diagram of a system comprising a programmable computing architecture configured to perform distributed ledger operations, in accordance with one or more implementations of the invention.

FIG. 5 depicts a flowchart of an example of a method for executing a smart contract in a programmable computing architecture physical separate from a computer processing unit, in accordance with one or more implementations of the invention.

### DETAILED DESCRIPTION OF THE INVENTION

The systems and methods described herein relate to a fixed pipeline hardware architecture configured to execute smart contracts in an isolated environment separate from a computing processing unit. Executing a smart contract may comprise performing a set of distributed ledger operations to modify a ledger associated with a decentralized application. The fixed pipeline hardware architecture may comprise and/or be incorporated within a self-contained hardware device comprising electronic circuitry configured to be communicatively coupled or physically attached to a component of a computer system. The hardware device may include local memory and an array of execution units. The hardware device may be specifically programmed to execute, and perform distributed ledger operations associated with, particular smart contracts, or types of smart contracts, that administer different decentralized applications and/or one or more aspects of different decentralized applications. By moving the execution of smart contracts to an isolated environment, the risks associated with attacks from hackers may be dramatically reduced.

It will be appreciated by those having skill in the art that the implementations described herein may be practiced without these specific details or with an equivalent arrangement. In other instances, well-known structures and devices are shown in block diagram form in order to avoid unnecessarily obscuring the implementations of the invention.

### Exemplary System Architecture

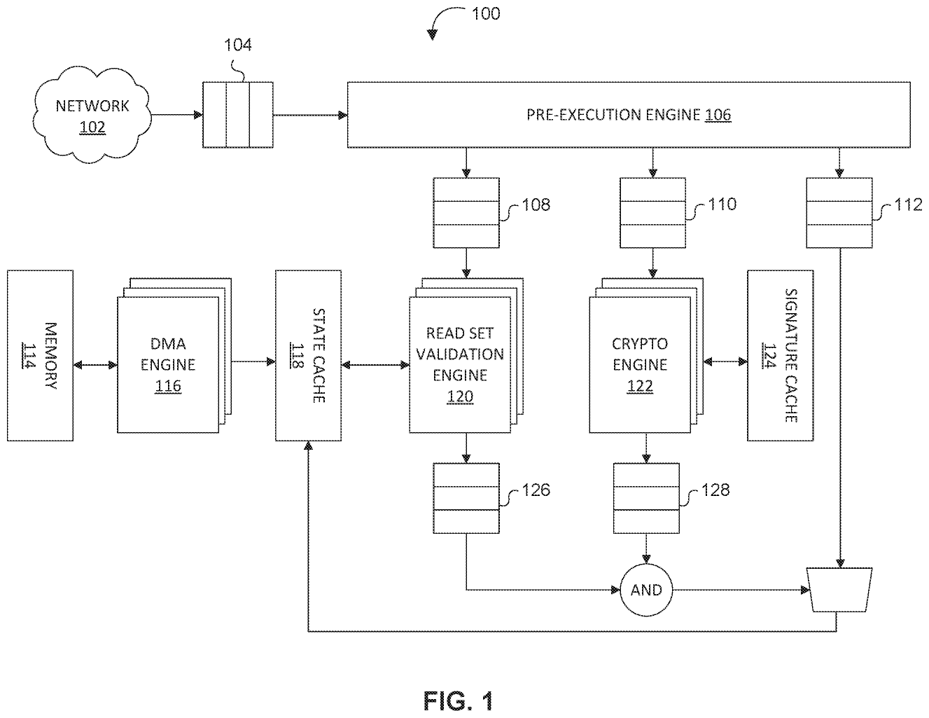

FIG. 1 depicts a block diagram of an example of a system 100 configured to process transaction verification operations in decentralized applications, in accordance with one or more implementations of the invention. In various implementations, system 100 may comprise a hardware device. For example, system 100 may comprise one or more processing devices (e.g., a digital processor, an analog processor, a digital circuit designed to process information, a central processing unit, a graphics processing unit, a microcontroller or microprocessor, an analog circuit designed to process information, a state machine, and/or other mechanisms for electronically processing information) configured to accelerate the transaction verification process. In some implementations, system 100 may comprise a single self-contained hardware device configured to be communicatively coupled or physically attached to a component of a computer system. In an exemplary implementation, system 100 may comprise electronic circuitry and/or a printed circuit board that can be inserted into an electrical connector or expansion slot of a computer system. For example, system 100 may comprise an expansion card, expansion board, adapter card, or accessory card configured to accelerate the transaction verification process. In some implementations, system 100 may comprise an application specific integrated circuit (ASIC) or a field-programmable gate array (FPGA) configured to perform transaction verification operations associated with one or more decentralized applications.

System 100 may include one or more hardware components. In various implementations, the one or more hardware components of system 100 may include an incoming block buffer 104, a pre-execution engine 106, a read set holding buffer 108, a signature validation buffer 110, a write set holding buffer 112, local memory 114, a DMA engine 116, a state cache 118, a read set validation engine 120, a crypto engine 122, a signature cache 124, a read set validation result buffer 126, a signature validation result buffer 128, and/or other components. In various implementations, the one or more hardware components of system 100 may form a fixed pipeline hardware architecture configured to accelerate the transaction verification process. For example, the one or more hardware components may configure system 100 to verify the authenticity of transactions in a block, check the validity of the transactions, and/or commit (or write) the block and the validation results onto the blockchain.

System 100 may be configured to accelerate the verification of transactions received via network 102. System 100 may be configured to receive a block comprising a set of transactions via network 102. In various implementations, incoming block buffer 104 may be configured to cache the received block. In some implementations, incoming block buffer 104 may be configured to cache the received block prior to pre-execution of the received block.

In various implementations, system 100 may include a pre-execution engine 106. Pre-execution engine 106 may be configured to conduct pre-execution of new transactions while a new block is being created. For example, pre-execution engine 106 may be configured to pre-execute transactions (and/or perform one or more transaction verification operations) for a decentralized application while a block comprising transactions is being generated as described in co-pending U.S. patent application Ser. No. 16/188,783, entitled “SYSTEMS AND METHODS FOR PRE-EXECUTING TRANSACTION VALIDATION FOR BLOCKCHAIN APPLICATIONS,” Attorney Docket No. 63PF-274819, the disclosure of which is hereby incorporated by reference in its entirety herein. By pre-executing the transaction validations, pre-execution engine 106 may significantly reduce the latency of a transaction's life cycle and greatly improve the throughput of a computer system to which system 100 is communicatively coupled and/or physically attached.

Blocks received and cached in incoming block buffer 104 may be inserted into one of a set of queues. A block comprising a set of transactions may include a ledger reading set, cryptographic signatures to be authenticated, and a ledger writing set. In various implementations, the ledger reading set of an incoming block may be inserted into read set holding buffer 108, cryptographic signatures of an incoming block to be authenticated may be inserted into signature validation buffer 110, and the ledger writing set of an incoming block may be inserted into write set holding buffer 112. In order for a transaction to be validated, both the ledger reading set and cryptographic signatures must be valid. If valid, the ledger writing set is applied to the global state (as described further herein). If not valid, the ledger writing set will not be applied to the global state. All valid information for a transaction is saved and committed (written) into the blockchain.

In various implementations, system 100 may include one or more of read set validation engine 120 and crypto engine 122. Accordingly, system 100 may include multiple read set validation engines 120 and/or multiple crypto engines 122. In some implementations, system 100 may include multiple read set validation engines 120 and/or multiple crypto engines 122 based on performance tradeoffs, cost tradeoffs, and/or power tradeoffs. As such, system 100 may be configurable based on the number of read set validation engines 120 and/or crypto engines 122 contained therein.

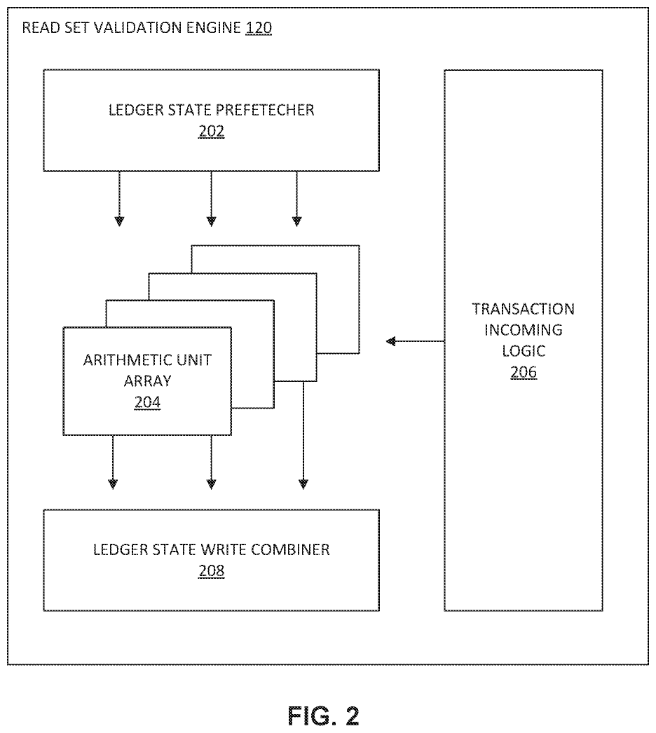

Each read set validation engine 120 may be configured to fetch ledger data and validate the ledger reading set against the global state. The global state may refer to the current status related to one or more data points in a verified ledger written to the blockchain. In various implementations, read set validation engine 120 may be configured to receive the ledger reading set of an incoming block from read set holding buffer 108. Read set validation engine 120 may be configured to interface with state cache 118 to obtain and cache data required to validate ledger reading set against the global state. In various implementations, the results of the ledger reading set validation by read set validation engine 120 may be cached in read set validation result buffer 126 at least until they are compared to results of the signature validation by crypto engine 122. Read set validation engine 120 is further described herein in connection with FIG. 2.

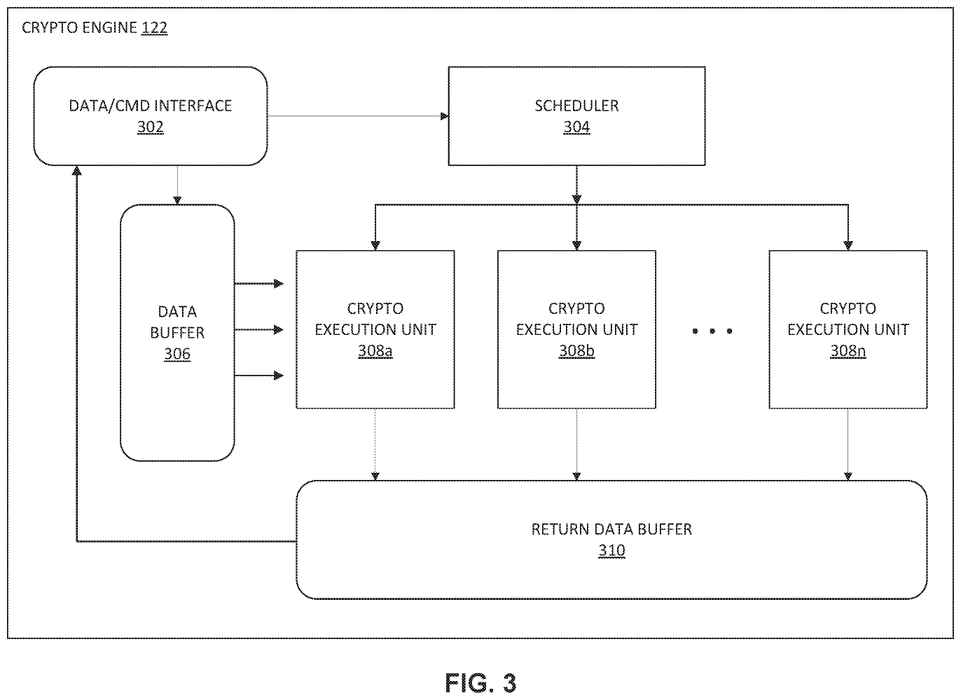

Each crypto engine 122 may comprise one or more cryptographic functional units. Each cryptographic functional unit may comprise a core configured to perform one or more cryptographic operations required to verify the authenticity of transactions in a block. For example, the one or more cryptographic operations may comprise crypto signature generation (encrypt) operations and crypto signature verification (decrypt) operations. In various implementations, crypto engine 122 may be configured to receive cryptographic signatures of a block to be authenticated from signature validation buffer 110. Crypto engine 122 may be configured to interface with signature cache 124 to obtain and cache data required to authenticate cryptographic signatures associated with a transaction. In various implementations, the results of the signature validation by crypto engine 122 may be cached in signature validation result buffer 128 at least until they are compared to results of the read set validation by read set validation engine 120. Crypto engine 122 is further described herein in connection with FIG. 3.

In various implementations, system 100 may comprise a direct memory access (DMA) engine 116. DMA engine 116 may be configured to fetch data required to verify the authenticity and read set data of a transaction. For example, DMA engine 116 may be configured to fetch existing blocks and signatures associated with a transaction. In various implementations, DMA engine 116 may be configured to access a ledger in memory required to validate data associated with a transaction. For example, DMA engine 116 may be configured to access local memory 114 to obtain a ledger required to validate data associated with a transaction.

In various implementations, read set validation result buffer 126 may comprise a cache of results of the ledger reading set validation by read set validation engine 120 and signature validation result buffer 128 may comprise a cache of the results of the signature validation by crypto engine 122.

In various implementations, system 100 may be configured to compare the results of the ledger reading set validation cached in read set validation result buffer 126 and the results of the signature validation cached in signature validation result buffer 128. Regardless of the results of the ledger reading set validation and the results of the signature validation or the comparison thereof, system 100 is configured to commit (or write) the transaction to the blockchain. However, based on the comparison of the results of the ledger reading set validation and the results of the signature validation, system 100 may also write the transaction to the state cache and update the global state based on the transaction. Specifically, if both the ledger reading set and the cryptographic signatures are valid, system 100 may be configured to write the transaction to the state cache and update the global state based on the transaction. In order to update the global state based on the transaction, the ledger writing set is applied to the global state. For example, if system 100 determines that both the ledger reading set and the cryptographic signatures are valid for a given transaction, a ledger writing set associated with that transaction cached in write set holding buffer 112 may be applied to the global state to update the global state based on the transaction. If either the ledger reading set or the cryptographic signatures are invalid, system 100 is specifically configured to not update the global state based on the transaction. If the ledger reading set is not valid, it may be due to the fact that there are insufficient funds to process the transaction or that the ledger reading set otherwise indicates that one or more conditions associated with the transaction have not been satisfied. Accordingly, system 100 will not process the transaction by updating the global state. Similarly, if the cryptographic signatures are invalid, it may indicate a potential hack has occurred. Accordingly, system 100 will not process the potentially fraudulent transaction by updating the global state.

In various implementations, the hardware device of system 100 may be configured to cooperate with a computer (or computer processing unit) that serves as a single node in a peer-to-peer network that is configured to process transactions associated with a decentralized application. For example, the hardware device may be installed in, communicatively coupled to, and/or otherwise associated with the computer. The computer may be physically and/or communicatively coupled to electronic storage configured to store a copy of a ledger shared by a plurality of nodes on the network. In some implementations, the copy of the ledger maintained and stored in electronic storage of the computer may comprise a read and write copy of the ledger. In other implementations, the copy of the ledger maintained and stored in electronic storage of the computer may comprise a read-only copy of the ledger. The computer may be configured to perform one or more distributed ledger operations based on the copy of the ledger stored in electronic storage. In various implementations, the hardware device of system 100 may be configured to maintain a shadow copy of the ledger shared by the plurality of nodes on the network and perform one or more distributed ledger operations based on the shadow copy of the ledger. In various implementations, the computer and the hardware device of system 100 may each be configured to perform one or more separate and distinct operations and maintain separate and distinct copies of the ledger shared by a plurality of nodes on a peer-to-peer network. For example, the computer and the hardware device may each perform one or more separate and distinct operations and maintain separate and distinct copies of the ledger as described in co-pending U.S. patent application Ser. No. 16/160,161, entitled “SYSTEMS AND METHODS FOR SECURE SMART CONTRACT EXECUTION VIA READ-ONLY DISTRIBUTED LEDGER,” Attorney Docket No. 63PF-274818, the disclosure of which is hereby incorporated by reference in its entirety herein.

### Read Set Validation

FIG. 2 illustrates a block diagram of an example of read set validation engine 120 configured to fetch ledger data and validate the ledger reading set against the global state, in accordance with one or more implementations of the invention. Read set validation engine 120 may comprise an architecture configured to validate read set data by determining whether a global state satisfies the current requirements of a transaction. In various implementations, one or more hardware components of read set validation engine 120 may form a fixed pipeline hardware architecture configured to fetch ledger data and validate the ledger reading set against the global state for a given transaction. In various implementations, the one or more hardware components of read set validation engine 120 may include a ledger state prefetcher 202, an arithmetic unit array 204, transaction incoming logic 206, a ledger state write combiner 208, and/or one or more other components. Read set validation engine 120 may be configured to obtain data necessary to validate the ledger reading set against the global state from local memory (such as memory 114 and/or state cache 118). In various implementations, read set validation engine 120 may include an input interface from DMA. For example, read set validation engine 120 may include an input interface from DMA engine 116.

In various implementations, read set validation engine 120 may comprise a ledger state prefetcher 202 configured to fetch data required by read set validation engine 120. In some implementations, ledger state prefetcher 202 may be configured to fetch a ledger state from state cache 118. In some implementations, ledger state prefetcher 202 may be configured to fetch a ledger state from state cache 118 via a high-speed memory interface. In some implementations, ledger state prefetcher 202 may be configured to prefetch a ledger state from state cache 118. Fetching from local memory would require accessing the entire memory, which would slow down throughput speed in the read set validation engine. Prefetching the ledger state from state cache 118 (which is local memory) would provide read set validation engine 120 with data from local memory without having to access the entire local memory for each computation. In various implementations, read set validation engine 120 may include transaction incoming logic 206 configured to extract state information from an incoming transaction. Accordingly, ledger state prefetcher 202 may be configured to obtain a local state from memory and transaction incoming logic 206 may be configured to obtain an incoming transaction state from the transaction data.

In various implementations, read set validation engine 120 may include arithmetic unit array 204 configured to perform a read set comparison against pre-executed results. In various implementations, arithmetic unit array 204 may be configured to perform computing tasks to verify transactions. In some implementations, arithmetic unit array 204 may be configured to operate in parallel. In other words, arithmetic unit array 204 may be configured to perform parallel processing of validation compute tasks for a single transaction and/or different transactions simultaneously. In various implementations, arithmetic unit array 204 may be configured to verify that a local copy of a state (obtained from memory) and the incoming transaction state match.

In various implementations, read set validation engine 120 may include ledger state write combiner 208 configured to perform a burst write for transaction results to the resulting buffer (i.e., read set validation result buffer 126). If an incoming transaction is validated (if the local copy of a state and the incoming transaction state match), ledger state write combiner 208 may be configured to combine states together and write to read set validation result buffer 126.

In an exemplary implementation in which a decentralized application involves a banking institution, each of the bank customers with an account may have their account written to a blockchain. Accordingly, the current status of each account and a history of every transaction involving each account is written to the blockchain, and the current status of each account would comprise the global state. In this exemplary implementation, system 100 may be configured to verify a block comprising a set of transactions involving bank customers. Transaction incoming logic 206 may be configured to obtain an incoming transaction state from the transaction data. For example, transaction incoming logic 206 may be configured to determine that a transaction involving a first bank customer involves a stock purchase for $3,000 and a transaction involving a second bank customer involves a transfer of $4,000. Read set validation engine 120 may be configured to obtain from memory (e.g., memory 114) a local state. The local state may comprise the global state indicating that a current account of the first customer comprises $2,000 and that a current account of the second customer comprises $8,000. Read set validation engine 120 may be configured to determine whether the current state meets the requirements for a given transaction. For example, arithmetic unit array 204 may be configured to compare the local state of the first customer (i.e., $2,000) and the incoming transaction state for the transaction involving the first customer (i.e., a transaction requiring $3,000), and compare the local state of the second customer (i.e., $8,000) and the incoming transaction state for the transaction involving the second customer ($4,000). Accordingly, read set validation engine 120 may be configured to determine that the transaction involving the first bank customer is invalid and that the transaction involving the second bank customer is valid.

In various implementations, the results of the ledger reading set validation by read set validation engine 120 may be cached in read set validation result buffer 126. For example, an indication that the transaction involving the first customer is invalid and an indication that the transaction involving the second customer is valid may be cached in read set validation result buffer 126. In various implementations, the results of the ledger reading set validation (i.e., the indication that the transaction involving the first customer is invalid and the indication that the transaction involving the second customer is valid) may be cached in read set validation result buffer 126 at least until they are compared to the results of the signature validation by crypto engine 122.

### Cryptographic Signature Validation

FIG. 3 illustrates a block diagram of an example of crypto engine 122 configured to perform one or more cryptographic operations required to verify the authenticity of transactions in a block, in accordance with one or more implementations of the invention. Crypto engine 122 may comprise an architecture configured to perform necessary cryptographic operations. In various implementations, one or more hardware components of crypto engine 122 may form a fixed pipeline hardware architecture configured to perform necessary cryptographic operations. In various implementations, the one or more hardware components of crypto engine 122 may include a data/CMD interface 302, a scheduler 304, a data buffer 306, one or more crypto execution units 308 (308a, 308b, . . . , 308n), a return data buffer 310, and/or one or more other components. In some implementations, crypto engine 122 may include multiple crypto execution units. For example, crypto engine 122 may include n-number of crypto execution units 308 wherein “n” is any number greater than 1. Crypto execution units 308 are also referred to herein as cryptographic execution units.

Cryptographic operations are implemented in system 100 via a highly-parallel architecture. In various implementations, crypto engine 122 may include multiple crypto execution units 308 configured to operate in parallel. In various implementations, crypto engine 122 may include multiple crypto execution units 308 configured to form a parallel cryptographic execution array. In various implementations, each individual crypto execution unit 308 is coupled to one or more other crypto execution units and is configured to share hardware resources with one or more other crypto execution units. For example, an individual crypto execution unit 308 may be configured to share a random number generator (e.g., shared random number generator 408) with one or more other crypto execution units. Other resources may be dedicated to individual crypto execution units. For example, one or more hardware resources (e.g., hashing and table lookup) may be dedicated to individual crypto execution units (e.g., crypto execution unit 308).

In various implementations, data required by one or more crypto execution units 308 may be obtained via data buffer 306. Data buffer 306 may be configured to cache data required to perform cryptographic operations related to authenticate cryptographic signatures for a block comprising a set of transactions. For example, data buffer 306 may be configured to cache algorithm parameters required to verify a cryptographic signature, hash values (e.g., hash public key and hash private key), and other data written to a block comprising a set of transactions crypto engine 122 is tasked to verify. In various implementations, data buffer 306 may be software-managed. In some implementations, data buffer 306 may be partitioned into different physical regions and each physical region may be associated with one or more different transactions. For example, each transaction may be assigned or be associated with a specific transaction ID. Each partitioned physical region of data buffer 306 may be associated with one or more specific transaction IDs. The partitioned nature of data buffer 306 enables information needed by the individual crypto execution units 308 to be easily accessed based on the transaction ID.

In various implementations, data buffer 306 may be configured to provide parameters to scheduler 304 to enable scheduler 304 to determine the type of algorithm required to authenticate a cryptographic signature, but withhold hash values that are much larger in size and are not required by scheduler 304 to make the foregoing determination. For example, hash values may comprise 512 bits, public keys and/or private keys may comprise 256 bits, and cryptographic algorithm parameters may comprise 256 bits. Scheduler 304 may be configured to determine cryptographic operations required to authenticate a cryptographic signature using only the cryptographic algorithm parameters. Data buffer 306 may obtain data via data/CMD interface 302. Data/CMD interface 302 may comprise a high-speed and/or high-bandwidth interface. For example, data/CMD interface 302 may comprise a PCIe electrical interface or an Ethernet networking interface. In some implementations, data buffer 306 may be configured to prefetch transaction data, signatures, private keys, and/or other information associated with transactions to be verified. Once a cryptographic operation has been dispatched to a specific crypto execution unit 308, that crypto execution unit 308 may be configured to access the required information to perform the cryptographic operation from data buffer 306.

In various implementations, scheduler 304 may be configured to identify the cryptographic operations required to authenticate one or more cryptographic signatures and dispatch tasks related to the cryptographic signatures to at least one of the one or more crypto execution units 308. For example, scheduler 304 may be configured to identify the cryptographic operations required to authenticate one or more cryptographic signatures and coordinate tasks related to the cryptographic signatures to be performed by an array of crypto execution units as described in co-pending U.S. patent application Ser. No. 16/122,406, entitled “SYSTEMS AND METHODS FOR ACCELERATING TRANSACTION VERIFICATION BY PERFORMING CRYPTOGRAPHIC COMPUTING TASKS IN PARALLEL,” Attorney Docket No. 63PF-274817, the disclosure of which is hereby incorporated by reference in its entirety herein.

Each cryptographic operation may require a specific algorithm. For example, the cryptographic operation may require the elliptic curve digital signature algorithm (ECDSA), the ECDH algorithm, the RSA algorithm, the ASE algorithm, the zk-SNARKs algorithms, and/or one or more other specific algorithms. Each algorithm may have different priorities and/or parameters. In various implementations, scheduler 304 may be configured to identify the algorithmic parameters associated with one or more cryptographic signatures. In various implementations, scheduler 304 may be configured to determine the type of algorithm required to authenticate a cryptographic signature and the relevant parameters, and dispatch the cryptographic signature to one of the one or more crypto execution units 308 based on the determination. In various implementations, scheduler 304 may be configured to determine the cryptographic operations required to authenticate one or more cryptographic signatures without accessing the hash values for the individual cryptographic signatures. In other words, scheduler 304 may be configured to determine the cryptographic operations required to authenticate one or more cryptographic signatures with only the algorithm and parameters associated with a given cryptographic signature to be verified.

In various implementations, scheduler 304 may be configured to cooperate with one or more software layers to support non-blocking transition cryptographic operations. For example, scheduler 304 may cooperate with one or more software layers to meet the demands of decentralized applications in which one or more transitions in a particular channel have a higher priority over other blocks. In some implementations, the one or more software layers may include a credit-control mechanism. The credit-control mechanism may comprise software configured to obtain an indication of the hardware limits and capabilities of system 100 and crypto execution units 308 in crypto engine 122 and verify that the number of transactions being processed does not exceed the hardware limits and capabilities of system 100 or crypto execution units 308. In some implementations, the credit-control mechanism may be configured to limit the number of transactions processed by system 100 at a given time to ensure the number of transactions being processed by system 100 does not exceed the hardware limits and capabilities of system 100. In some implementations, scheduler 304 may interface with the credit-control mechanism to limit the number of cryptographic operations being routed to individual crypto execution units 308 at a given time to ensure the number of cryptographic tasks being routed to individual crypto execution units 308 does not exceed the hardware limits and capabilities of system 100.

In some implementations, cryptographic operations may be dispatched by scheduler 304 to only a subset of the one or more crypto execution units 308. As such, one or more of a set of crypto execution units 308 may be idle at a given time while other crypto execution units 308 are performing cryptographic operations. In various implementations, crypto engine 122 may comprise a dispatcher configured to control the main dataflow for each crypto execution unit 308.

In various implementations, each of the one or more crypto execution units 308 may be associated with one or more cryptographic operations or one or more types of cryptographic operations. In other words, the one or more crypto execution units 308 may be configurable for different decentralized applications. For example, crypto execution unit 308a may be configured to perform a first cryptographic operation and crypto execution unit 308b may be configured to perform a second cryptographic operation. Accordingly, when operating in parallel, different cryptographic operations may performed simultaneously by different crypto execution units 308 configured to perform specific cryptographic operations.

In various implementations, each crypto execution unit 308 may be configured to support one or more of a set of macro operations required to authenticate one or more cryptographic signatures and verify a transaction in a decentralized application. For example, each crypto execution unit 308 may be configured to perform one or more of elliptic curve point multiplication; a SHA-1 hash function; modular addition, multiplication, and/or inversion; random number generation; and/or one or more other operations required to authenticate one or more cryptographic signatures and verify a transaction in a decentralized application.

Each crypto execution unit 308 may be configured to operate in parallel and perform one or more cryptographic operations required to verify the authenticity of transactions in a block. Because each of the crypto execution units may be associated with one or more cryptographic operations, the crypto execution units may be configurable for different decentralized applications. Accordingly, the implementation of each crypto execution unit 308 varies according to different elliptic curve parameters. Scheduler 304 is configured to issue specific cryptographic operations into the fitting crypto execution unit 308 based on the curve parameters associated with the required cryptographic operation, as described herein.

In some implementations, at least one crypto execution unit 308 may be configured to perform cryptographic operations related to the elliptic curve digital signature algorithm (ECDSA). For example, crypto engine 122 may be comprise at least one crypto execution unit 308 configured to perform cryptographic operations related to the elliptic curve digital signature algorithm (ECDSA) as described in co-pending U.S. patent application Ser. No. 16/122,406, entitled “SYSTEMS AND METHODS FOR ACCELERATING TRANSACTION VERIFICATION BY PERFORMING CRYPTOGRAPHIC COMPUTING TASKS IN PARALLEL,” Attorney Docket No. 63PF-274817, the disclosure of which is hereby incorporated by reference in its entirety herein.

Each crypto execution unit 308 of crypto engine 122 may be of the same type or a different type of one or more of the other crypto execution units 308 of crypto engine 122. For example, the types of crypto execution units 308 included within crypto engine 122 may include ECDSA SECP256K1 encrypt, ECDSA SECP256R1 encrypt, RSA encrypt, ASE encrypt, ECDH encrypt, Zk-SNARKs encrypt, ECDSA SECP256K1 decrypt, ECDSA SECP256R1 decrypt, RSA decrypt, ASE decrypt, ECDH decrypt, Zk-SNARKs decrypt, and/or one or more other types of crypto execution units.

In various implementations, each result of cryptographic operations performed by one of the one or more crypto execution units 308 may be temporarily stored in return data buffer 310. The time required to perform different cryptographic operations may vary. Accordingly, crypto execution units 308 may require different amounts of time to perform their assigned cryptographic operation. As such, in some implementations, the results from the cryptographic operations performed for a given block or set of transactions may be provided by crypto execution units 308 at different times. Accordingly, return data buffer 310 may be configured to temporarily store the results of cryptographic operations performed by crypto execution units 308 and reorder the results before the results are cached in signature validation result buffer 128.

In various implementations, return data buffer 310 may be software-managed. In some implementations, return data buffer 310 may be partitioned into different physical regions and each physical region may be associated with one or more different transactions. For example, each transaction may be assigned or be associated with a specific transaction ID. Each partitioned physical region of return data buffer 310 may be associated with one or more specific transaction IDs. Based on the transaction ID assigned to a given transaction, return data buffer 310 may be configured to push back the return value of the results of the signature validation by crypto engine 122 to data/CMD interface 302 in a software-defined order. In some implementations, data/CMD interface 302 may be configured to cause the results of the signature validation by crypto engine 122 that are pushed back to be cached in signature validation result buffer 128. The partitioned nature of return data buffer 310 enables the results of the individual cryptographic operations performed by the one or more crypto execution units 308 to be easily accessed and ordered based on the transaction ID to facilitate transaction verification for the transaction associated with the transaction ID by system 100.

### Programmable System Architecture

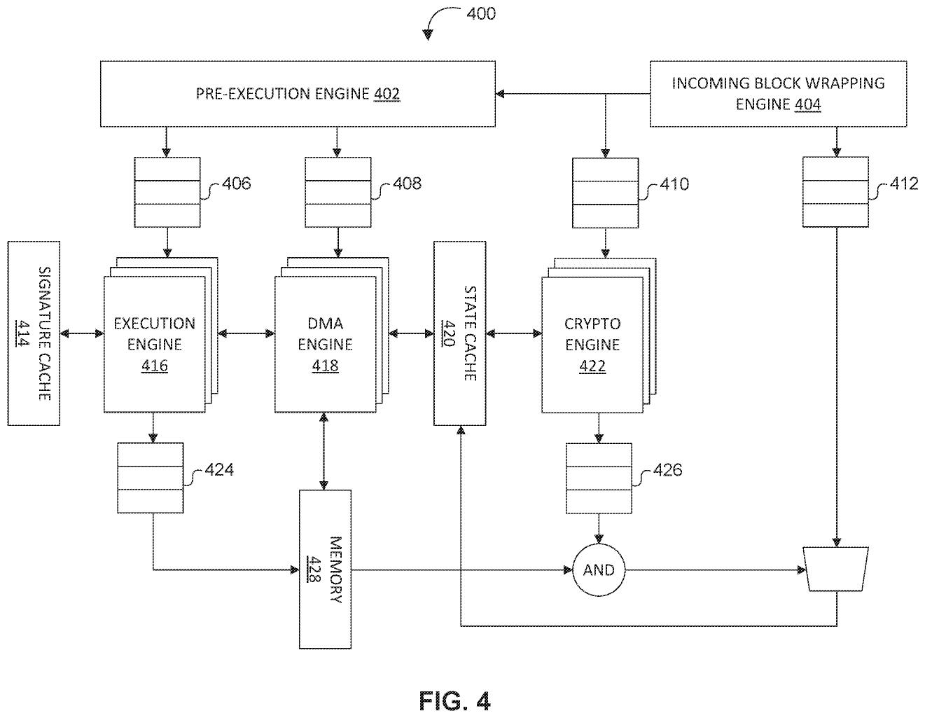

FIG. 4 illustrates a block diagram of a system 400 comprising a programmable computing architecture configured to perform distributed ledger operations, in accordance with one or more implementations of the invention. In various implementations, the computing architecture of system 400 may represent a computing architecture for a single node in a peer-to-peer network that is configured to process transactions associated with a decentralized application.

In various implementations, system 400 may comprise a hardware device. For example, system 400 may comprise one or more processing devices configured to perform various distributed ledger operations associated with a wide range of decentralized applications. In some implementations, system 400 may comprise a single self-contained hardware device configured to be communicatively coupled or physically attached to a component of a computer system. For example, system 400 may comprise an expansion card, expansion board, adapter card, or accessory card and/or other component configured to be communicatively coupled or physically attached to a component of a computer system. In some implementations, system 400 may comprise an application specific integrated circuit (ASIC) or a field-programmable gate array (FPGA) that may be specifically programmed to perform various distributed ledger operations associated with a wide range of decentralized applications.

In various implementations, system 400 may be configured to execute one or more smart contracts. In other words, the hardware device comprising system 400 may itself be configured to execute smart contracts. Typically, smart contracts are executed on a CPU. By moving the smart contract execution to a hardware device (such as an expansion card, expansion board, adapter card, accessory card, ASIC, FPGA, and/or other component configured to be communicatively coupled or physically attached to a component of a computer system), the smart contracts are executed in an isolated environment, which may dramatically reduce the risks associated with attacks from hackers. For example, the risk of roll back attacks would be dramatically reduced as blockchain ledger state and versioned data may all be locally stored in system 400.

In various implementations, system 400 may be specifically programmed to execute, and perform distributed ledger operations associated with, particular smart contracts, or types of smart contracts, that administer different decentralized applications and/or one or more aspects of different decentralized applications. For example, computer program instructions stored in local memory of system 400 may be configured to program, or enable the programming of, one or more execution units (e.g., one or more execution units of execution engine 416) to execute specific smart contracts. In various implementations, the computer program instructions, when executed by system 400 (or one or more components of system 400) configure an array of execution units included in system 400 to perform one or more distributed ledger operations required to execute a smart contract of a decentralized application. For example, system 400 may be programmed such that mathematical operations required to execute a smart contract are performed by execution engine 416, memory access operations required to execute a smart contract are performed by DMA engine 418, and cryptographic operations required to execute a smart contract are performed by crypto engine 422.

In various implementations, the computer program instructions may include instructions for an instruction set architecture (ISA) that may serve as an interface between computer program instructions and various hardware components of system 400. For example, the computer program instructions may include a RISC-V ISA. In various implementations, system 400 may be configured to receive computer program instructions that program one or more execution units of system 400 to execute specific smart contracts. In various implementations, an ISA stored in local memory of system 400 may serve as an interface between received computer program instructions and one or more hardware components of system 400, thus facilitating the programming of system 400. In various implementations, the ISA stored in local memory of system 400 may be fully compatible with one or more mainstream virtual machine instruction sets, such as the Ethereum Virtual Machine instruction set. In other words, system 400 may be specifically programmed (e.g., with user input comprising computer program instructions) to execute any smart contract created using, and/or compatible with, the Ethereum Virtual Machine (EVM). In some implementations, system 400 may be configured to execute only smart contracts created using EVM and/or one or more other specific instruction sets. Restricting the smart contracts that are compatible with system 400 to smart contracts created using EVM reduces the risk of side channel attacks.

In various implementations, system 400 may include one or more hardware components. In some implementations, system 400 may comprise a hardware device the same as or similar to system 100 described with respect to FIG. 1 above. For example, system 400 may include one or more of the hardware components describe above with respect to system 100, and/or one or more other components described below. In various implementations, the one or more hardware components of system 400 may be situated on a single semiconductor platform. For example, the one or more hardware components of system 400 may be situated on a single semiconductor-based integrated chip or circuit.

The one or more hardware components of system 400 may include an a pre-execution engine 402, an incoming block wrapper 404, an incoming block buffer 406, a ledger data prefetch buffer 408, a private key buffer 410, a special command buffer 412, a signature cache 414, an execution engine 416, a DMA engine 418, a state cache 420, a crypto engine 422, an execution result buffer 424, a signature validation result buffer 426, local memory 428, and/or other components. In various implementations, the one or more hardware components of system 400 may form a fixed pipeline hardware architecture configured to perform various distributed ledger operations associated with a wide range of decentralized applications.

System 400 may be configured to receive and execute one or more types of smart contract transactions. For example, system 400 may be configured to receive and execute smart contract transactions related to payment, lottery, auction, lending, and/or one or more other types of smart contract transactions. In various implementations, system 400 may be configured to receive a block comprising at least one smart contract transaction. In some implementations, system 400 may include a pre-execution engine 402 and/or an incoming block wrapper 404. Pre-execution engine 402 may comprise a pre-execution engine the same as or similar to pre-execution engine 106 described with respect to FIG. 1 above. In various implementations, incoming block buffer 406 may be configured to cache the received block. For example, incoming block buffer 406 may be configured to cache the received block prior to execution of a smart contract of the received block by execution engine 416.

As described above, system 400 may be specifically programmed to execute, and perform distributed ledger operations associated with, particular smart contracts or types of smart contracts. The array of execution units included in system 400 (i.e., at least execution engine 416, DMA engine 418, and crypto engine 422) may be capable of performing each distributed ledger operations required to execute a smart contract. As such, the hardware device (or system 400) may be configured to fully execute any smart contract. For example, by programming the programmable hardware device (or system 400), the array of execution units may be configured to execute any smart contract now known or future developed.

Performing the distributed ledger operations in order dramatically reduces the risk of side channel attacks. In various implementations, each type of smart contract may require different distributed ledger operations and/or the performance of distributed ledger operations in a different order. In various implementations, system 400 may be programmed with computer program instructions to perform different distributed ledger operations associated with a given smart contract, or type of smart contract, in the appropriate order. For example, system 400 may be specifically programmed to perform distributed ledger operations, in the appropriate order, for smart contracts related to payment transactions, a lottery (or wager), an auction, lending, and/or one or more other types of smart contracts.

In various implementations, DMA engine 418 may be configured to fetch data required to execute a smart contract. For example, DMA engine 418 may be configured to fetch ledger data required execute a smart contract. In some implementations, DMA engine 418 may be configured to fetch ledger data from state cache 420 and/or local memory 428. In some implementations, DMA engine 418 may comprise a DMA engine the same as or similar to DMA engine 116 described with respect to FIG. 1 above. In some implementations, state cache 420 may comprise a cache the same as or similar to state cache 118 described with respect to FIG. 1 above. In various implementations, prefetched ledger data may be cached in ledger data prefetching buffer 408. In some implementations, DMA engine 418 may be configured to cache prefetched ledger data in ledger data prefetching buffer 408. In some implementations, DMA engine 418 may be configured to obtain prefetched ledger data cached in ledger data prefetching buffer 408 and utilize the cached ledger data to obtain the data necessary to execute a smart contract from local memory 428.

In various implementations, the array of execution units of system 400 may include a crypto engine 422 comprising one or more cryptographic functional units. In various implementations, crypto engine 422 may comprise a crypto engine the same as or similar to crypto engine 122 described with respect to FIG. 1 and FIG. 3 above. Each cryptographic functional unit may comprise a core configured to perform one or more cryptographic operations required to verify the authenticity of transactions in a block related to a given smart contract. In various implementations, crypto engine 422 may be configured to receive cryptographic signatures of a block to be authenticated from private key buffer 410. In various implementations, private key buffer 410 may comprise a buffer the same as or similar to signature validation buffer 110 described with respect to FIG. 1 above. Crypto engine 422 may be configured to interface with signature cache 414 to obtain and cache data required to authenticate cryptographic signatures associated with a smart contract. In various implementations, the results of the signature validation by crypto engine 422 may be cached in signature validation result buffer 426.

In various implementations, the array of execution units of system 400 may include execution engine 416. In various implementations, execution unit 416 may be configured to perform mathematical operations required to execute a smart contract. For example, many smart contracts require the performance of simple add, subtract, multiplication, division, and/or other simple mathematical operations to execute the smart contract. As described below with respect to the example implementations for smart contracts related to payment transactions, a lottery or wager, an auction, and/or lending (or a loan), different smart contracts require different mathematical operations. In some implementations, different mathematical operations required to execute different types of smart contracts involve comparing transaction data to a local state in a ledger (e.g., for a payment transaction), determining whether conditions have been satisfied (e.g., comparing certain smart contract conditions with obtained data in a lottery or wager), comparing transaction data from different blocks (e.g., in an auction), and/or other simple mathematical operations. In some implementations, execution engine 416 may comprise an execution engine the same as or similar to read set validation engine 120 described with respect to FIG. 1 and FIG. 2 above. In various implementations, the results of the mathematical operations performed by execution engine 416 may be cached in execution result buffer 424. In some implementations, execution result buffer 424 may comprise a buffer the same as or similar to read set validation result buffer 126 described with respect to FIG. 1 above.

In various implementations, local memory 428 may be configured to store one or more smart contracts and/or data related to one or more smart contracts. In various implementations, local memory 428 may be configured to store data and/or computer program instructions required to execute one or more types of smart contracts. For example, local memory 428 may be configured to store computer program instructions configured to program, or enable the programming of, one or more execution units (e.g., an array of execution units of system) to execute specific smart contracts. In various implementations, the computer program instructions, when executed by system 400 (or one or more components of system 400) configure an array of execution units included in system 400 to perform one or more distributed ledger operations required to execute a smart contract of a decentralized application. In some implementations, local memory 428 may be configured to store instructions for an ISA that may serve as an interface between computer program instructions and various hardware components of system 400. In some implementations, local memory 428 may be configured to store computer program instructions received from a user that are configured to that program one or more execution units of system 400 to execute specific smart contracts.

Based on the results of the operations performed by execution unit 424 (i.e., the results cached in execution result buffer 424) and the operations performed by crypto engine 422 (i.e., the results cached in signature validation result buffer 426), system 400 may determine whether and how to update a ledger based on a smart contract and update the ledger accordingly.

In an example implementation, system 400 may be specifically programmed to execute a smart contract related to a payment transaction. For example, computer program instructions may be received that program one or more execution units of system 400 to execute smart contracts related to payment transactions by performing one or more distributed ledger operations in order. For example, to execute a smart contract related to the payment of $100 from a first user to a second user, the computer program instructions may program system 400 to perform one or more distributed ledger operations in a particular order. First, DMA engine 418 may be configured to fetch from state cache 420 and/or local memory 428 a local state indicating a value in an account of the first user as recorded in a ledger shared by a plurality of nodes on a peer-to-peer network. Second, crypto engine 422 may be configured to obtain a private key from private key buffer 410 and use the private key to decrypt the fetched data to access the account of the first user. Third, execution engine 422 may be configured to perform simple mathematical operations to determine whether the first user has adequate funds (e.g., at least $100 to process the transaction) and determine an updated value for the account of the first user (e.g., the previous value minus $100). Fourth, crypto engine 422 may be configured to encrypt the updated value for writing the updated value to the ledger. System 400 may then write the updated value to the ledger. In various implementations, system 400 may be programmed by one or more computer program instructions to perform some or all of the foregoing operations, one or more additional operations, and/or perform the foregoing operations in a different order. In various implementations, system 400 may be programmed by computer program instructions to perform payment transactions in a predefined order. For example, as described above, computer program instructions that program system 400 to execute smart contracts related to payment transactions may include, in order, a prefetch instruction (for DMA engine 418), an decrypt instruction (for crypto engine 422), a mathematical instruction (for execution engine 416), an encrypt instruction (for crypto engine 422, a commit instruction, which causes the ledger to be updated. The computer program instructions that program system 400 to execute smart contracts related to payment transactions may specify the operations to be performed and the order in which to preform them.

In an example implementation, system 400 may be specifically programmed to execute a smart contract related to a lottery or wager. For example, a wager may involve a predefined condition—if a specific team wins a game, a first user pays a second user $100. Executing a smart contract related to a wager may involve each of the operations required to execute a smart contract related to a payment transaction. However, as indicated above, executing the smart contract related to the wager may also include at least one additional operation to determine whether a predefined condition has been satisfied. As such, computer program instructions that program system 400 to execute smart contracts related to wagers may also include an initial instruction to determine whether the predefined condition has occurred. For example, the initial instruction may program execution engine 416 to perform a mathematical operation to determine whether the condition has been satisfied. If, based on the mathematical operation performed by execution engine 416, system 400 determines that the predefined condition has been satisfied, the computer program instructions may be configured to program system 400 to execute a payment transaction to settle the wager.

In an example implementation, system 400 may be specifically programmed to execute a smart contract related to an auction. For example, executing a smart contract related to an auction may require fetching specific data related to the smart contract and performing one or more specific distributed ledger operations. The specific data may include auction parameters (e.g., a start time, an end time, rules regarding bids to be placed, rules restricting who is permitted to place a bid, and/or one or more other auction parameters), bids received, account information for individuals who have placed bids, account information for individuals placing the items up for auction, and/or other specific data. To execute a smart contract related to the an auction, the computer program instructions may program system 400 to perform one or more distributed ledger operations in a particular order. For example, DMA engine 418 may be configured to fetch auction parameters that identify rules for bids received. Execution engine 416 may be configured to compare bids received, and data associated with bids received (e.g., a time at which the bid was received or who submitted the bid), to the auction parameters to determine whether a bid is valid. Execution engine 416 may then be configured to compare bids received to identify a winning bid. The remaining operations may comprise the same operations, in the same orders, as executing a smart contract related to a payment transaction, as described in the example implementation above.

### Exemplary Flowcharts of Processes

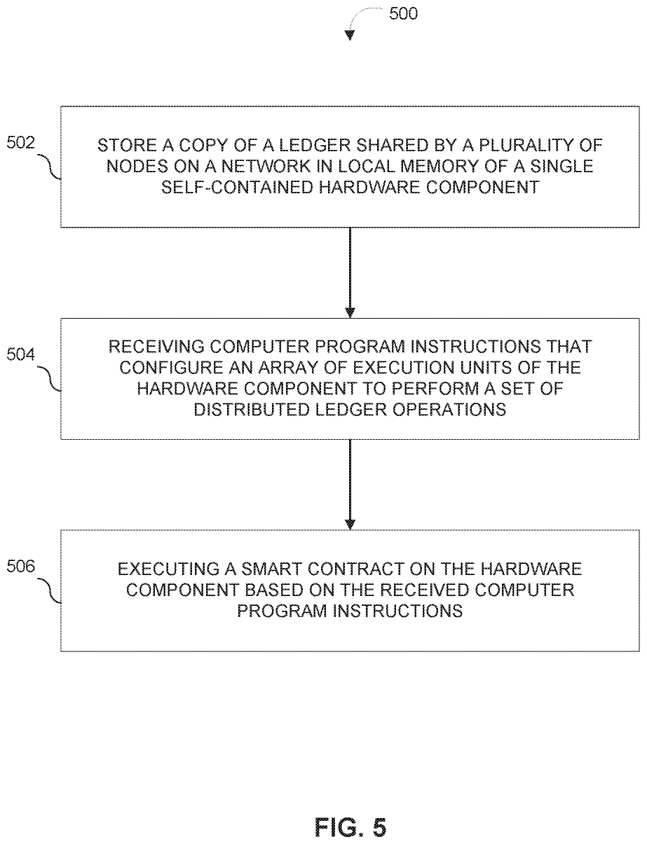

FIG. 5 illustrates a method 500 for executing a smart contract in a programmable computing architecture physical separate from a computer processing unit, in accordance with one or more implementations of the invention. Executing the smart contract may comprise performing a set of distributed ledger operations to modify a ledger associated with a decentralized application. The operations of method 500 presented below are intended to be illustrative and, as such, should not be viewed as limiting. In some implementations, method 500 may be accomplished with one or more additional operations not described, and/or without one or more of the operations discussed. In some implementations, two or more of the operations may occur substantially simultaneously. The described operations may be accomplished using some or all of the system components described in detail above.

In some implementations, method 500 may be implemented in one or more processing devices (e.g., a digital processor, an analog processor, a digital circuit designed to process information, a central processing unit, a graphics processing unit, a microcontroller, an analog circuit designed to process information, a state machine, and/or other mechanisms for electronically processing information). The one or more processing devices may include one or more devices executing some or all of the operations of method 500 in response to instructions stored electronically on one or more electronic storage mediums. The one or more processing devices may include one or more devices configured through hardware, firmware, and/or software to be specifically designed for execution of one or more of the operations of method 500.

In some implementations, one or more operations of method 500 may be implemented via a hardware device configured to be communicatively coupled or physically attached to a component of a computer system. For example, one or more operations of method 500 may be implemented via the hardware device described above with respect to system 100 and/or system 400. The hardware device described above with respect to system 100 and/or system 400 may include one or more hardware components configured through firmware and/or software to be specifically designed for execution of one or more operations of method 500. In some implementations, one or more operations of method 500 may be implemented on an application specific integrated circuit (ASIC) or a field-programmable gate array (FPGA) specifically designed for execution of one or more operations of method 500. In some implementations, one or more operations of method 500 may be implemented on a single semiconductor platform. For example, the one or more operations of method 500 may be implemented on a single semiconductor-based integrated chip or circuit. In some implementations, one or more operations of method 500 may be implemented via one or more hardware components described with respect to system 400. For example, one or more operations of method 500 may be implemented by a single self-contained hardware component that includes local memory and an array of execution units.

In an operation 502, method 500 may include storing a copy of a ledger shared by a plurality of nodes on a network in local memory of a single self-contained hardware component. In various implementations, smart contracts to be executed by the self-contained hardware component may be stored on the local memory of the self-contained hardware component. The local memory may be physically separate from the local memory of a corresponding CPU. In various implementations, instructions for an instruction set architecture may be stored in the local memory. The instruction set architecture may comprise an interface between received computer program instructions and components of the hardware component (e.g., an array of execution units on the hardware component).

In an operation 504, method 500 may include receiving computer program instructions that configure an array of execution units of the hardware component to perform a set of distributed ledger operations. The received computer program instructions may include instructions that indicate a set of distributed ledger operations required to execute a smart contract, and an order in which to perform the set of distributed ledger operations. In various implementations, the hardware component may be configured to execute any smart contracts compatible with one or more virtual machine instruction sets. In various implementations, the array of execution units may be capable of performing each distributed ledger operation required to execute one or more types of smart contracts. In various implementations, the array of execution units may include execution units configured to perform mathematical operations required to execute a smart contract. In various implementations, the array of execution units may include a set of cryptographic execution units configured to operate in parallel. Each of the set of cryptographic execution units may be configured to perform one or more type of cryptographic operations. In various implementations, the array of execution units may include a memory access component configured to fetch data from local memory. The fetched data may comprise data that is required to execute the smart contract and verify whether cryptographic signatures associated with the smart contract are valid. In some implementations, the computer program instructions received may configure an array of execution units of the hardware component to perform distributed ledger operations necessary to execute a first type of smart contract. In various implementations, the hardware component may be programmed to execute various types of smart contracts. For example, computer program instructions may be received by the hardware component that configure the array of execution units of the hardware component to perform distributed ledger operations necessary to execute a second type of smart contract.

In an operation 506, method 500 may include executing a smart contract on the hardware component based on the received computer program instructions. In various implementations, the set of distributed ledger operations required to execute a smart contract, which are identified in the computer program instructions, may be performed by the array of execution units. The set of distributed ledger operations may be executed by the array of execution units in the order defined by the received computer program instructions. In various implementations, operation 506 may be performed by one or more execution units the same as or similar to execution engine 416, DMA engine 418, and/or crypto engine 422 (shown in FIG. 4 and described herein), and/or one or more other components described herein.

Implementations of the disclosure may be made in hardware, firmware, software, or any suitable combination thereof. Aspects of the disclosure may be implemented as instructions stored on a machine-readable medium, which may be read and executed by one or more processors. A machine-readable medium may include any mechanism for storing or transmitting information in a form readable by a machine (e.g., a computing device). For example, a tangible computer readable storage medium may include read only memory, random access memory, magnetic disk storage media, optical storage media, flash memory devices, and others, and a machine-readable transmission media may include forms of propagated signals, such as carrier waves, infrared signals, digital signals, and others. Firmware, software, routines, or instructions may be described herein in terms of specific exemplary aspects and implementations of the disclosure, and performing certain actions.

Although illustrated in FIG. 1 and FIG. 4 as a single component, system 100 and system 400, respectively, may each include a plurality of individual components (e.g., computer devices) each programmed with at least some of the functions described herein. In this manner, some components of system 100 and system 400 may perform some functions while other components may perform other functions, as would be appreciated.

The various components illustrated in FIG. 1 and FIG. 4 may be coupled to at least one other component via a network (e.g., network 102), which may include any one or more of, for instance, the Internet, an intranet, a PAN (Personal Area Network), a LAN (Local Area Network), a WAN (Wide Area Network), a SAN (Storage Area Network), a MAN (Metropolitan Area Network), a wireless network, a cellular communications network, a Public Switched Telephone Network, and/or other network. In FIG. 1 and FIG. 4, as well as in other drawing Figures, different numbers of entities than those depicted may be used. Furthermore, according to various implementations, the components described herein may be implemented in hardware and/or software that configure hardware.

For purposes of explanation, numerous specific details are set forth in order to provide a thorough understanding of the description. It will be apparent, however, to one skilled in the art that implementations of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein. For example, the use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Reference in this specification to “one implementation”, “an implementation”, “some implementations”, “various implementations”, “certain implementations”, “other implementations”, “one series of implementations”, or the like means that a particular feature, design, structure, or characteristic described in connection with the implementation is included in at least one implementation of the disclosure. The appearances of, for example, the phrase “in one implementation” or “in an implementation” in various places in the specification are not necessarily all referring to the same implementation, nor are separate or alternative implementations mutually exclusive of other implementations. Moreover, whether or not there is express reference to an “implementation” or the like, various features are described, which may be variously combined and included in some implementations, but also variously omitted in other implementations. Similarly, various features are described that may be preferences or requirements for some implementations, but not other implementations.

The various features and processes described above may be used independently of one another, or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The example systems and components described herein may be configured differently than described. For example, elements may be added to, removed from, or rearranged compared to the disclosed example embodiments.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

It will be appreciated that an “engine,” “system,” “data store,” and/or “database” may comprise software, hardware, firmware, and/or circuitry. In one example, one or more software programs comprising instructions capable of being executable by a processor may perform one or more of the functions of the engines, data stores, databases, or systems described herein. In another example, circuitry may perform the same or similar functions. Alternative embodiments may comprise more, less, or functionally equivalent engines, systems, data stores, or databases, and still be within the scope of present embodiments. For example, the functionality of the various systems, engines, data stores, and/or databases may be combined or divided differently.

The language used herein has been principally selected for readability and instructional purposes, and it may not have been selected to delineate or circumscribe the inventive subject matter. Other implementations, uses, and advantages of the invention will be apparent to those skilled in the art from consideration of the specification and practice of the invention disclosed herein. The specification should be considered exemplary only, and the scope of the invention is accordingly intended to be limited only by the following claims.

What is claimed is:

1. A system configured to execute in an isolated environment a smart contract related to a decentralized application, wherein executing the smart contract comprises performing a set of distributed ledger operations to modify a ledger associated with the decentralized application, the system comprising:
a single self-contained hardware component configured to be communicatively coupled or physically attached to a computer system, the hardware component comprising local memory and an array of execution units capable of performing each distributed ledger operation required to execute one or more types of smart contracts,
wherein the local memory is configured to store a copy of the ledger shared by a plurality of nodes on a network and computer program instructions that, when executed by the hardware component, configure the array of execution units to perform the set of distributed ledger operations in a predefined order.

2. The system of claim 1, wherein the smart contract comprises a first type of smart contract, and wherein the hardware component is further configured to:
receive computer program instructions that, when executed by the hardware component, configure the array of execution units to perform a second set of distributed ledger operations required to execute a second type of smart contract.

3. The system of claim 2, wherein the local memory is configured to store instructions for an instruction set architecture, wherein the instruction set architecture comprises an interface between the received computer program instructions and components of the hardware component, the components including the array of execution units.

4. The system of claim 1, wherein hardware component is configured to execute smart contracts compatible with one or more virtual machine instruction sets.

5. The system of claim 1, wherein the local memory is further configured to store the smart contract.

6. The system of claim 1, wherein the array of execution units includes execution units configured to perform mathematical operations required to execute a smart contract.

7. The system of claim 1, wherein the array of execution units includes a set of cryptographic execution units configured to operate in parallel, wherein each of the set of cryptographic execution units is configured to perform one or more type of cryptographic operations.

8. The system of claim 1, wherein the array of execution units includes a memory access component configured to fetch data from the local memory, the fetched data comprising data that is required to execute the smart contract and verify whether cryptographic signatures associated with the smart contract are valid.

9. The system of claim 1, wherein the hardware component comprises an application specific integrated circuit (ASIC) or a field-programmable gate array (FPGA).

10. A method of executing a smart contract in a programmable computing architecture physical separate from a computer processing unit, wherein executing the smart contract comprises performing a set of distributed ledger operations to modify a ledger associated with the decentralized application, the method being implemented by a single self-contained hardware component that includes local memory and an array of execution units, the method comprising:
storing, in local memory, a copy of a ledger shared by a plurality of nodes on a network;
receiving, by the hardware component, computer program instructions that, when executed by the hardware component, configure the array of execution units to perform the set of distributed ledger operations in a predefined order, wherein the array of execution units are capable of performing each distributed ledger operation required to execute one or more types of smart contracts; and
executing, by the hardware component, the smart contract based on the received computer program instructions.

11. The method of claim 10, wherein the received computer program instructions indicate the set of distributed ledger operations and define an order for performing the distributed ledger operations, wherein executing the smart contract based on the computer program instructions comprises:
performing, by the array of execution units, the set of distributed ledger operations in the order defined by the received computer program instructions.

12. The method of claim 10, wherein the smart contract comprises a first type of smart contract, the method further comprising:
receiving, by the hardware component, computer program instructions that, when executed by the hardware component, configure the array of execution units to perform a second set of distributed ledger operations required to execute a second type of smart contract.

13. The method of claim 10, the method further comprising:
storing, by the local memory, instructions for an instruction set architecture, wherein the instruction set architecture comprises an interface between the received computer program instructions and components of the hardware component, the components including the array of execution units.

14. The method of claim 10, wherein hardware component is configured to execute smart contracts compatible with one or more virtual machine instruction sets.

15. The method of claim 10, the method further comprising:
storing, by the local memory, the smart contract.

16. The method of claim 10, wherein the array of execution units includes execution units configured to perform mathematical operations required to execute a smart contract.

17. The method of claim 10, wherein the array of execution units includes a set of cryptographic execution units configured to operate in parallel, wherein each of the set of cryptographic execution units is configured to perform one or more type of cryptographic operations.

18. The method of claim 10, wherein the array of execution units includes a memory access component configured to fetch data from the local memory, the fetched data comprising data that is required to execute the smart contract and verify whether cryptographic signatures associated with the smart contract are valid.

19. The method of claim 10, wherein the hardware component comprises an application specific integrated circuit (ASIC) or a field-programmable gate array (FPGA).
